(19) United States
(12) Patent Application Publication
(10) Pub. No.: US 2012/0055116 A1
(43) Pub. Date: Mar. 8, 2012

(54) GERM GUARD LABEL AND METHODS FOR USING A GERM GUARD LABEL

(75) Inventor: Kathryn Jeanne Neiheiser, Strongsville, OH (US)

(73) Assignee: KD DIVERSIFIED, LLC, Painesville, OH (US)

(21) Appl. No.: 13/222,768

(22) Filed: Aug. 31, 2011

Related U.S. Application Data
(60) Provisional application No. 61/379,791, filed on Sep. 3, 2010.

(51) Int. Cl. B65B 55/00; B67B 1/03; B65B 55/06; B65B 61/02

(52) U.S. Cl. 53/425; 53/411; 53/426

(57) ABSTRACT

Described herein is a germ guard label and methods of using the same. A germ guard label at least substantially conformal to an oral transmission area of an object can prevent or limit transmission of contaminants like germs, for example, from person to person. When an infected person touches an object covered with a germ guard label, germs transmitted from the infected person can contaminate the germ guard label rather than the object. Another person can remove the contaminated germ guard label from the object, and the oral contact area of the object covered by the germ guard label can be substantially germ free. The germ guard label also can prevent spillage of a substance from the oral contact area.

### CROSS REFERENCE TO RELATED CASES

This application claims the priority of and expressly incorporates by reference the following application: U.S. Provisional Patent Application Ser. No. 61/379,791, “GERM GUARD LABEL AND METHODS FOR USING A GERM GUARD LABEL,” which was filed on Sep. 3, 2010

### TECHNICAL FIELD

Described herein are germ guard labels and, in particular, systems and methods that employ germ guard labels to prevent disease transmission.

### BACKGROUND

A person can be exposed to disease-causing germs and other infectious agents through simple acts, such as touching a contaminated object. For example, a person can be exposed to viruses, like influenza or the common cold, or bacteria, like staphylococcus or streptococcus, by simply touching a contaminated object.

For example, an object can become contaminated is when an infected person touches the object. Germs can be transferred from the infected person's hand to the object. In some cases, germs can live on the object for hours after the initial touch. A healthy person can be exposed to the germs when he or she touches the contaminated object.

### SUMMARY

The following presents a simplified summary of the invention in order to provide a basic understanding of some aspects of the invention. This summary is not an extensive overview of the invention and is not intended to identify key/critical elements of the invention or to delineate the scope of the invention. Rather, the sole purpose of this summary is to prevent some concepts of the invention in a simplified form as a prelude to the more detailed description that is presented later.

Described herein is a germ guard label for a beverage container (e.g., a beverage container or a cup) and methods of using the same. The germ guard label can shield the beverage container from contaminants, including communicable diseases like influenza, the common cold, streptococcus or staphylococcus. For example, when a person carrying germs, like influenza, touches a beverage container covered with a germ guard label, germs transmitted from the germ carrying person can contaminate the germ guard label rather than the beverage container. Another person can remove the contaminated germ guard label from the object (e.g., by pulling on a tab), and the area of the object covered by the germ guard label will be substantially germ free. The germ guard label also can prevent spillage of a substance from the oral contact area.

To the accomplishment of the foregoing and related ends, the invention comprises the features hereinafter fully described and particularly pointed out in the claims. The following description and the annexed drawings set forth in detail certain illustrative aspects and implementations of the invention. These are indicative, however, of but a few of the various ways in which the principles of the invention can be employed. Other objects, advantages and features of the invention will become apparent from the following detailed description of the invention when considered in conjunction with the drawings.

### BRIEF DESCRIPTION OF THE DRAWINGS

FIG. 1 is an illustration of a method for applying a germ guard label to an object to prevent transmission of a contaminant from an object to a human.

FIG. 2 is an illustration of a method for thermoforming a germ guard label to an object to prevent transmission of a contaminant from the object to a human.

FIG. 3 is an illustration of a method for applying a germ guard label to a clean object to prevent transmission of a contaminant from the object to a human.

FIG. 4 is an illustration of a method for applying a germ guard label to a clean, dry object to prevent transmission of a contaminant from the object to a human.

FIG. 5 is an illustration of a method for applying a germ guard label to a sterile object to prevent transmission of germs from the object to a human.

FIG. 6 is an illustration of a method for applying a germ guard label to a clean, sterile object to prevent transmission of a contaminant or germs from the object to a human.

FIG. 7 is an illustration of a method for applying a germ guard label to a clean, dry, sterile object to prevent transmission of a contaminant or germs from the object to a human.

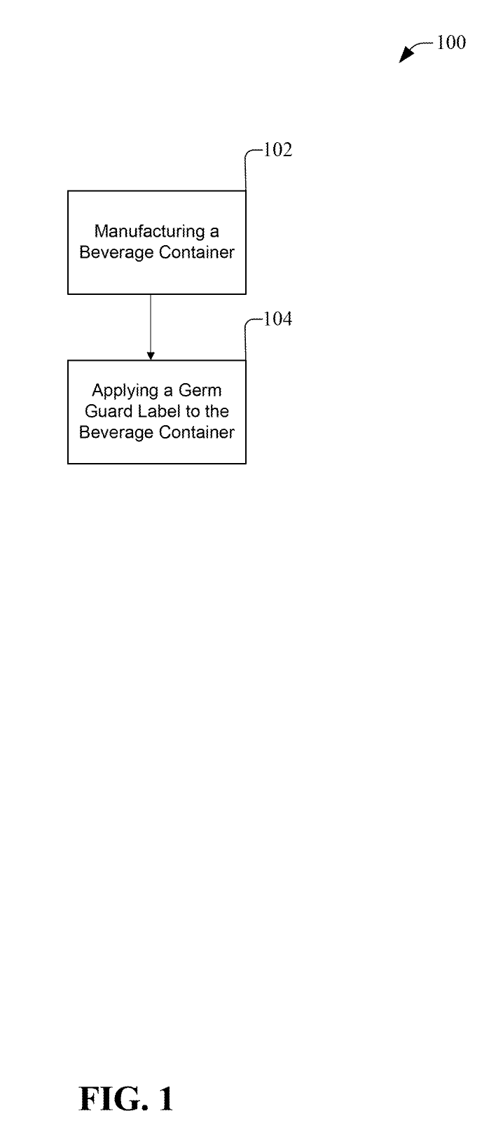

FIGS. 1-7 illustrate methodologies and/or flow diagrams in accordance with the disclosed subject matter. For simplicity of explanation, the methods are depicted and described as a series of acts. It is to be understood and appreciated that the subject innovation is not limited by the acts illustrated and/or by the order of acts and with other acts not presented and described herein. Furthermore, not all illustrated acts may be required to implement the methodologies in accordance with the disclosed subject matter. Further, it can be appreciated that the order of acts shown is but one example, and the order of various acts shown can be interchanged or combined with other acts not shown without departing from the scope of the invention.

### DETAILED DESCRIPTION

Described herein are germ guard labels and, in particular, systems and methods that employ germ guard labels to prevent transmission of germs and other contaminants from an object to a human.

The invention is now described with reference to the drawings, wherein like reference numerals are used to refer to like elements throughout. In the following description, for purposes of explanation, numerous specific details are set forth in order to provide a thorough understanding of the subject invention. It can be evident, however, that the invention can be practiced without these specific details. In other instances, well-known structures and devices are shown in block diagram form in order to facilitate describing the invention.

Referring now to FIG. 1, illustrated is a method 100 for applying a germ guard label to a beverage container. The beverage container can be any container that is configured to hold a beverage that a person can drink from. Examples of beverage containers can include aluminum cans, tin cans, plastic bottles, glass bottles, plastic cups, Styrofoam cups, and the like. The beverage container is understood to have an “oral contact area” or an area that contacts the mouth to facilitate drinking the beverage.

At 102, a beverage container is manufactured. This manufacturing can include any process for making and filling a beverage container. In a case where the beverage container is a can be a pop-top can, various processes can be employed to make and fill the can. The process can be a mechanical cold forming process or a two-piece drawing and wall ironing method. With regard to the two-piece drawing and wall ironing method, the body of the can is formed, the can is filled, the lid is added, and the can is seamed shut.

A manufacturing process can include cleaning or sterilization processes. Cleaning processes can ensure that the surface of the beverage container is free or substantially free of dirt, mold, or any other unclean entity. Sterilization processes can remove all or substantially all disease-causing agents, such as bacteria or other germs, from the beverage container. In this context, substantially all can correspond to limits defined by the U.S. Food and Drug Administration or other regulatory agency as “safe” for food contact. The levels of unclean entities or germs can be a trace amount still deemed “safe” for human consumption.

At 104, a germ guard label can be attached to the beverage container, covering the oral contact area. The germ guard label can be constructed from any food grade material approved by the U.S. Food and Drug Administration or other regulatory agency for oral contact, and can be a recyclable material. Examples of food grade materials can include various types of plastic, paper, fiberboard, cellulosic material, combinations of these materials or the like. Examples of plastics can include one or more of polylactate, polycarbonate (PC), polypropylene (PP), polyethylene (e.g., high-density polyethylene (HDPE), low density polyethylene (LDPE), polyethylene terephthalate (PET)), polyvinyl chloride (PVC or vinyl), polystyrene (PS), etc. The germ guard label can include a biopolymer, such as cellulose or cellulose acetate. Germ guard labels can be made from a thin, flexible material, such as a thin film; germ guard labels can also be made of a sturdier material, such as a thermoplastic. The germ guard label can be cellophane and/or a shrink film.

The germ guard labels can be transparent, translucent, transparent with one or more colors or opaque with one or more colors. Germ guard labels can be any color or combination of colors. Germ guard labels can be any combination of shades of color or colors. Additionally or alternatively, germ guard labels can include any combination of graphic designs or logos.

The germ guard label can cover any amount of the beverage container, as long as the entire oral contact area is covered by the germ guard label. In other words, the germ guard label can cover at least the oral contact area of the beverage container. The germ guard label can cover any amount of the beverage container up to and including the entire beverage container.

The germ guard label can be a variety of different shapes and sizes, as long as it can cover at least the oral contact area. In the case where the beverage container is a pop-top can, the oral contact area can extend to a rim of the can. The germ guard label can also cover any place that a hand is likely to touch, like the side of a can. This can reduce the risk of germ transmission.

By covering at least the oral contact area of the beverage container, germ guard labels can act as a physical barrier and/or shield to limit or prevent the spread of germs and other contaminants. Contaminants can include germs (e.g., influenza, the common cold, streptococcus or staphylococcus), dirt, dust, fungus or heavy metals. When a person infected with germs touches the beverage container covered with the germ guard label, germs transmitted from the infected person can contaminate the germ guard label rather than the beverage container. Another person can remove the contaminated germ guard label from the beverage container, and the area of the object covered by the germ guard label including the oral contact area will be substantially germ free. The germ guard label also can prevent spillage of a substance from the oral contact area.

The germ guard label can have a thickness between a thin film and the lid itself. For example, the thickness of the germ guard label can be between 0.01 and 150 millimeters. Further for example, the thickness of the germ guard label can be between 1 and 90 millimeters. Furthermore, for example, the thickness of the germ guard label can be between 1 millimeters and 10 millimeters.

A germ guard label can be conformal or substantially conformal to the oral contact area of the beverage container. The germ guard label can be understood to be substantially conformal if the germ guard label prevents disease-causing agents, like germs, to enter the oral contact area while the germ guard label is attached to the beverage container. The germ guard label can be removably attached to the beverage container by any method that does not utilize an adhesive, such as thermoforming, vacuumforming, static electricity, any method utilizing chemical or mechanical properties of the material, or the like. The germ guard label can include a tab of any shape or size that can facilitate removal of the germ guard label from the beverage container, such as a half-moon or a rectangle of any size smaller than the germ guard label itself. Perforations can also be utilized to facilitate removal of the germ guard label from the beverage container.

The material can provide antimicrobial properties, for example, through pre-treatment, inherent material properties, or the like. The material can be pre-treated with an antimicrobial agent. The antimicrobial agent can be any antimicrobial agent or combination of antimicrobial agents that are approved by the Food and Drug Administration or other regulatory agency. The antimicrobial can include any active against one or more of bacteria, viruses, fungi or any other contaminant, such as silver or silver ions, zinc or zinc ions, triclosan (2,4,4′-trichloro-2′-hydroxydiphenol or 50chloro-2-(2,4,-dichlorophenoxy)phenol), chemical antimicrobials, antioxidants, biotechnology products, antimicrobial polymers, natural antimicrobials or gas, or any other antimicrobial agent. The germ guard label can be, for example, polystyrene (PS) coated with a silver or silver ion-containing antimicrobial agent.

The germ guard label can be imbibed, impregnated, treated, or the like with the antimicrobial agent. In other words, the antimicrobial agent can be incorporated directly within a polymer, coated on the surface of the polymer, or adsorbed on the surface of the polymer.

The antimicrobial agent can include a biocidal and/or a biostatic agent(s). The biocidal and/or biostatic agent can be capable of slowing or inhibiting the growth or reproduction of microorganisms, including bacteria, molds, fungi, viruses and the like. The biocidal agent can be a biocide (life destroying), which can be a bacteriacide and fungicide (inhibiting the growth of microorganisms and destroying the microorganisms). The biocide can also be antiviral. The biocide can be a broad spectrum biocide, and generally, a wide ranging antimicrobial, inhibiting a broad range of microorganisms. The antimicrobial can be effective at controlling or killing bacteria, such as gram positive, gram negative, aerobic and anaerobic types, viruses, fungi, etc. Any biocide that is compatible with the material of the germ guard label before fabrication and will retain its activity after fabrication can be used in connection with the germ guard label.

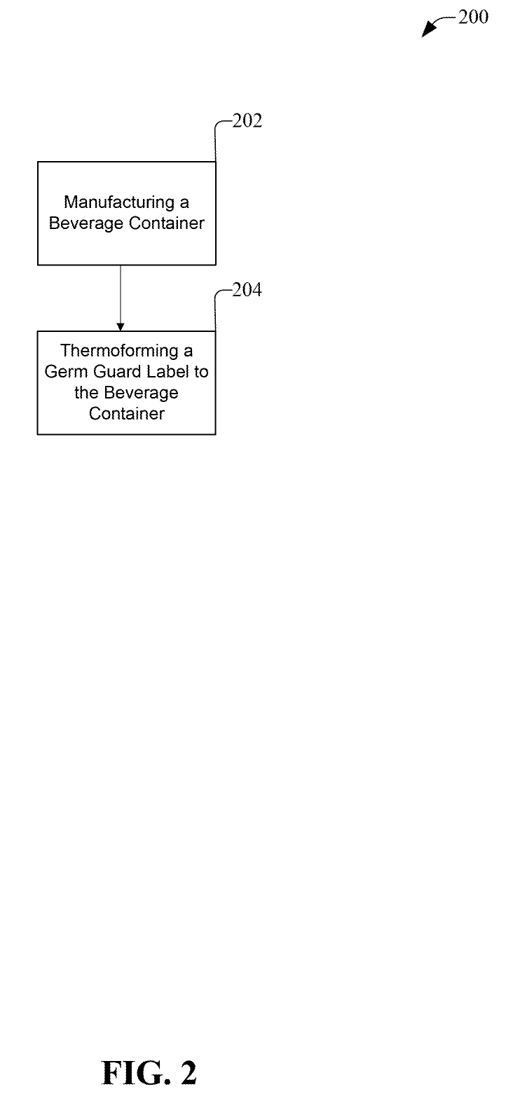

Referring now to FIG. 2, illustrated is a method 200 for applying a germ guard label to a beverage container. At 202, the beverage container is manufactured and filled, as described above. At 204, the germ guard label is affixed to the beverage container by a thermoforming process. The thermoforming process is just one example of a process that can allow the germ guard label to be conformal or substantially conformal to the oral contact area of the beverage container. Other examples can include vacuum forming processes, shrink wrapping processes, processes utilizing suction, processes utilizing static electricity, processes utilizing static cling or the like. These processes can include any process that forms the germ guard label so that it is removably attached to the beverage container without adhesive. Accordingly, no adhesive residue is left on the beverage container upon removing the germ guard label. The process for adding the germ guard label can be added as a step in the manufacture of the beverage container.

Thermoforming is a method of manufacturing whereby sheets of thin plastic material area heated, then vacuum formed to a desired shape (e.g., a shape greater than or equal to the oral contact area of the beverage container). Excess material then can be cut away (e.g., by die cutting). This can allow a thermoformed germ guard label to be conformal or substantially conformal to the oral contact area of the beverage container until it is physically removed. The process of thermoforming can be utilized with a thin material, for example less than 1.5 mm thickness, to form a thin germ guard label conformal or substantially conformal with the beverage container.

The germ guard label can be removably attached to the surface of the beverage container without the need for an adhesive that can leave a residue on the beverage container upon removal of the germ guard label. Thermoforming heats a plastic sheet into a pliable forming temperature so that it can be formed to a specific shape in a mold corresponding to the beverage container. Upon forming the sheet into the shape that at least covers the oral contact area of the beverage container, the sheet can be trimmed to create the germ guard label. The thermoforming process can be included as a step in the beverage container manufacturing process.

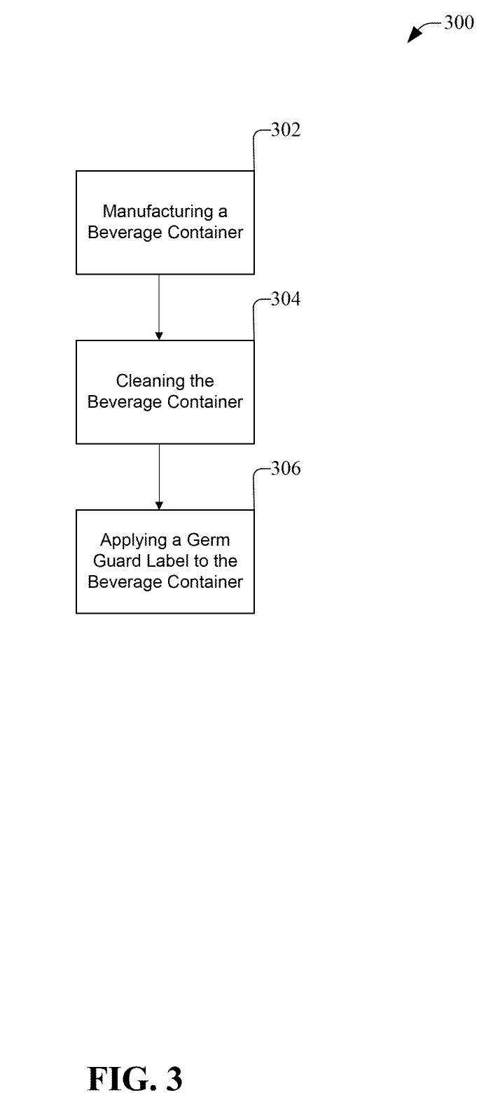

Referring now to FIG. 3, illustrated is a method 300 for applying a germ guard label to a beverage container. At 302, the beverage container is manufactured, as described above. At 304, the beverage container is cleaned. According to an example, if the beverage container is an aluminum can, the beverage container can be cleaned to remove excess aluminum and other contaminants from the outside of the can. The beverage container can be cleaned with a water rinse, a commercial cleanser, a liquid acidic cleaner, a liquid alkaline cleaner, or any other cleaning formulation or process approved by the US Food and Drug Administration or other regulatory body. At 306, the germ guard label can be attached to the beverage container in any manner to at least substantially conform to the oral contact area of the beverage container. Manners of attachment can include thermoforming, vacuum forming, shrink wrapping, suction, static electricity, static cling, or the like.

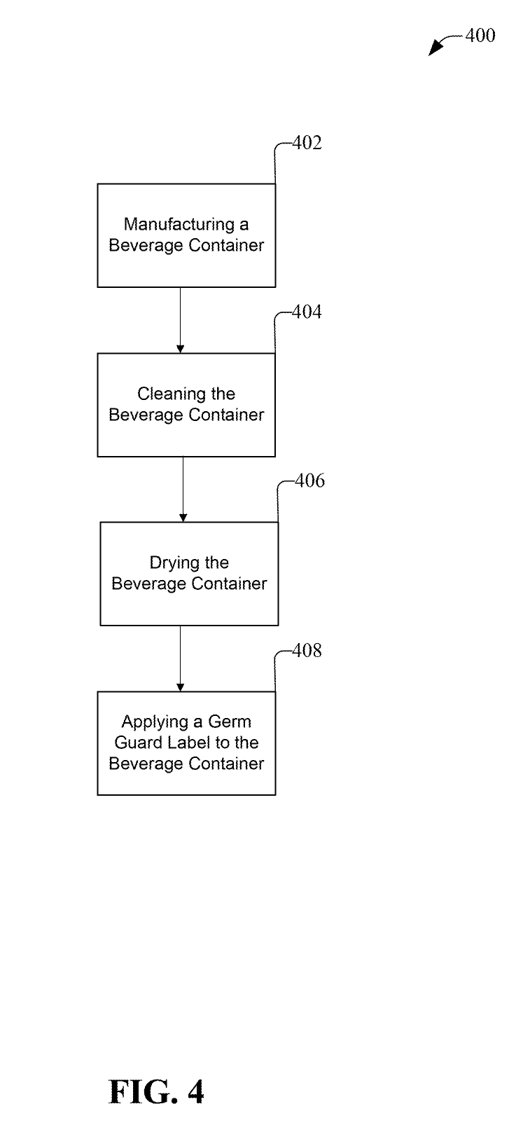

Regarding FIG. 4, illustrated is a method 400 for applying a germ guard label to a beverage container. At 402, the beverage container is manufactured and filled in any method as described above. At 404, the beverage container is cleaned in any method as described above. At 406, the beverage container is dried. The beverage container can be dried in an oven, spray-dried, or dried according to any drying process approved by the U.S. Food and Drug Administration or any other regulatory authority. At 408, the germ guard label can be attached to the beverage container in any manner that does not include adhesives so that the germ guard label is at least substantially conformal to the oral contact area of the beverage container.

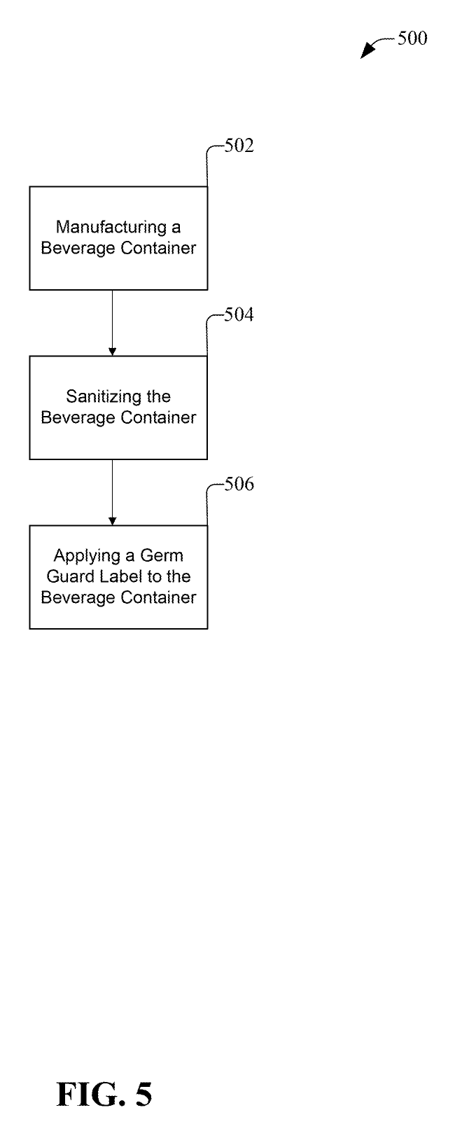

Regarding FIG. 5, illustrated is a method 500 for applying a germ guard label to a beverage container. At 502, the beverage container is manufactured and filled, as described above. At 504, the beverage container is sanitized and/or sterilized to remove any germs from the surface. Any method of sanitization can be used, including thermal sanitization, ultraviolet sanitization, x-ray sanitization, chemical sanitization, or any method of sanitization approved by the U.S. Food and Drug Administration or any other regulatory authority. One example of a sanitization can include dry heat, where the beverage container can be exposed to a high temperature (e.g., greater than about 100 degrees Celsius) for a period of time (e.g., greater than 1 hour). At 506, the germ guard label can be attached to the beverage container without adhesive in any manner so that the germ guard label is at least substantially conformal to the oral contact area of the beverage container.

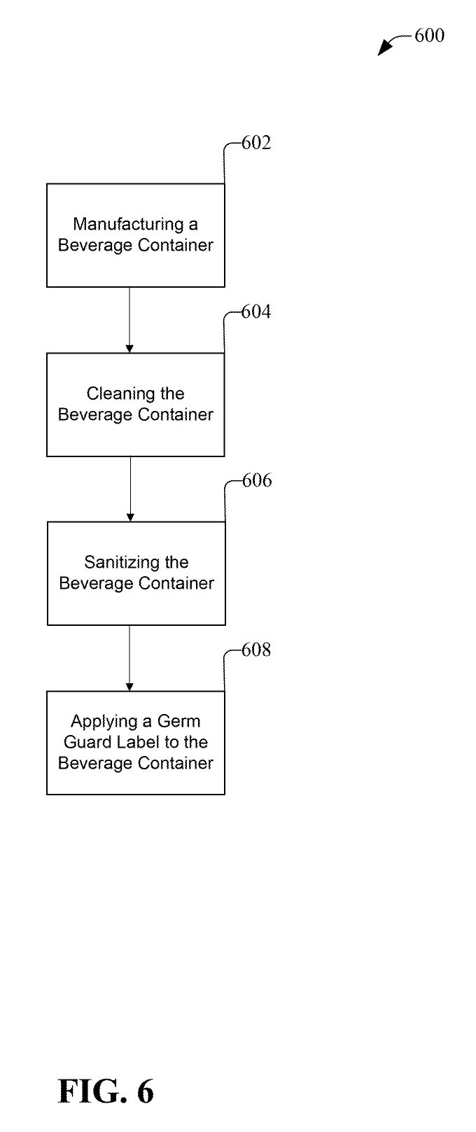

Regarding FIG. 6, illustrated is a method 600 for applying a germ guard label to a beverage container. At 602, the beverage container is manufactured and filled, as described above. At 604, the beverage container is cleaned to remove any dirt or residue from the manufacturing process using any method approved for oral contact by a regulatory agency, as described above. At 606, the beverage container is sanitized and/or sterilized to remove any germs from the surface using any method as described above. At 608, the germ guard label can be attached to the beverage container in any manner to at least substantially conform to the oral contact area of the beverage container. Accordingly, the germ guard label can be attached to a clean, sterile surface.

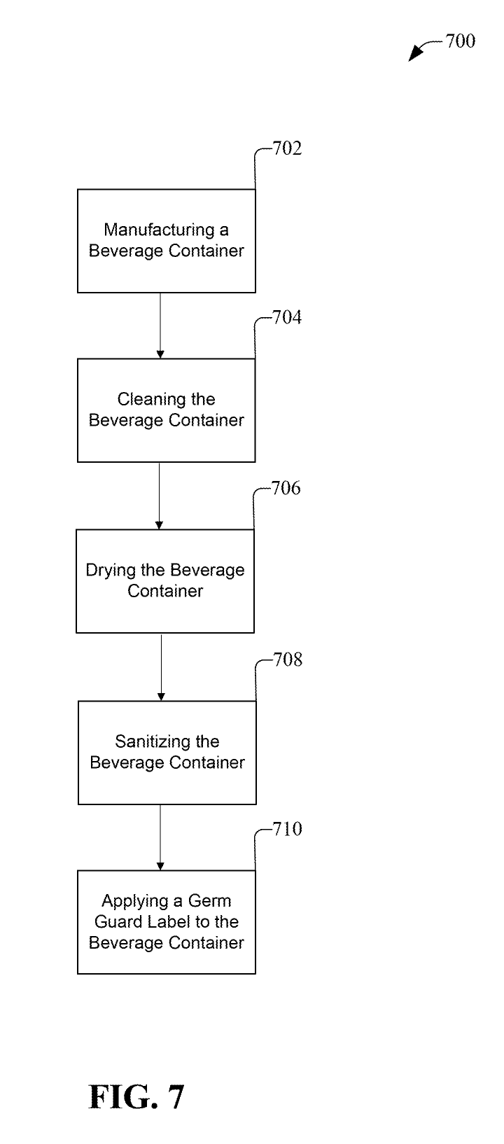

Regarding FIG. 7, illustrated is a method 700 for applying a germ guard label to a beverage container. At 702, the beverage container is manufactured and filled, as described above. At 704, the beverage container is cleaned to remove any dirt or aluminum residue using any method as described above. At 706, the beverage container is dried using any method as described above. At 708, the beverage container is sanitized and/or sterilized to remove any germs from the surface using any method as described above. At 710, the germ guard label can be attached to the beverage container in any manner to at least substantially conform to the oral contact area of the beverage container. Accordingly, the germ guard label can be attached to a clean, sterile surface.

A germ guard label can be applied to a pop-top can, such as a can housing beer or soft drink. The beverage container can be cleaned and/or sanitized before the germ guard label is applied. The germ guard label can be formed to the beverage container so that the germ guard label is at least substantially conformal to the oral contact area of the beverage container without using an adhesive so that the germ guard label can be removably affixed to the can. The germ guard label can be formed with a tab, perforations, or anything that can facilitate removal of the germ guard label from the oral contact area. The germ guard label can be any size or shape, as long as it is at least the size and shape of the oral contact area. For example, the germ guard label can cover the entire lid of the pop-top can in an oval shape, a circle shape, or the like. The germ guard label can be treated with an antibiotic coating (e.g., containing silver or silver ions) so that germs are not spread from a person handling the container to a person drinking from the container.

With respect to any figure or numerical range for a given characteristic, a figure or a parameter from one range can be combined with another figure or a parameter from a different range for the same characteristic to generate a numerical range.

Other than in the operating examples, or where otherwise indicated, all numbers, values and/or expressions referring to quantities of ingredients, reaction conditions, etc., used in the specification and claims are to be understood as modified in all instances by the term “about.”

What has been described above includes examples of the present specification. It is, of course, not possible to describe every conceivable combination of components or methodologies for purposes of describing the present specification, but one of ordinary skill in the art can recognize that can further combinations and permutations of the present specification are possible. Accordingly, the present specification is intended to embrace all such alterations, modifications and verifications that fall within the spirit and scope of the appended claims. In addition, while a particular feature of the invention can have been disclosed with respect to only one of several embodiments, such feature can be combined with one or more other features of the other embodiments as can be desired and advantageous for any given or particular application. Furthermore, to the extent that the term “includes” is used either in the detailed description or the claims, such term is intended to be inclusive in a manner similar to the term “comprising” as “comprising” is interpreted when employed as a transitional word in a claim.

What is claimed is:

1. A method for applying a label that prevents contaminant transmission, comprising:
thermoforming a food grade material having a shape sufficient to at least correspond to an oral contact area of an object to the object,
wherein the food grade material is at least substantially conformal to the object.

2. The method of claim 1, wherein the object is a beverage container.

3. The method of claim 1, further comprising treating the food grade material with an antimicrobial agent.

4. The method of claim 3, wherein the antimicrobial agent contains silver.

5. The method of claim 1, further comprising cleaning the object.

6. The method of claim 5, further comprising drying the object.

7. The method of claim 1, further comprising sanitizing the object.

8. The method of claim 1, wherein the food grade material having a shape sufficient to correspond to an area greater than the top lid of the object.

9. The method of claim 1, further comprising:
cleaning the object;
drying the object; and
sanitizing the object.

10. A method for applying a label that prevents contaminant transmission, comprising:
at least one of cleaning a beverage container or sanitizing the beverage container; and
applying a food grade material having a shape sufficient to at least correspond to an oral contact area of the beverage container so that the food grade material is at least substantially conformal to the beverage container,
wherein the food grade material comprises antimicrobial properties.

11. The method of claim 10, wherein the beverage container is a pull-top can.

12. The method of claim 10, wherein the applying further comprises removably attaching the food grade material to the beverage container.

13. A method for applying a label that prevents contaminant transmission, comprising:
at least one of sanitizing a beverage container or sterilizing a beverage container; and
applying a germ guard label to the beverage container,
wherein the germ guard label is at least substantially conformal to an oral contact area of the beverage container.

14. The method of claim 13, further comprising treating the germ guard label with an antimicrobial agent.

15. The method of claim 14, wherein the germ antimicrobial agent comprises silver.

16. The method of claim 13, wherein the applying further comprises thermoforming the germ guard label to the beverage container.

17. The method of claim 13, wherein the sterilizing further comprises heating the beverage container to a temperature greater than 100 degrees Celsius.

18. The method of claim 13, wherein the sterilizing further comprises heating the beverage container to a temperature greater than 120 degrees Celsius.

19. The method of claim 13, wherein the sterilizing further comprises heating the beverage container to a temperature greater than 200 degrees Celsius.

20. The method of claim 13, wherein the applying further comprises removably attaching the germ guard label to the beverage container.
